(19) United States
(12) Patent Application Publication
(10) Pub. No.: US 2025/0372910 A1
(43) Pub. Date: Dec. 4, 2025

(54) CONNECTOR

(71) Applicant: YAZAKI CORPORATION, Tokyo (JP)

(72) Inventors: Yosuke AKAGI, Shizuoka (JP); Kaoru MATSUMURA, Shizuoka (JP)

(73) Assignee: YAZAKI CORPORATION, Tokyo (JP)

(21) Appl. No.: 19/218,912

(22) Filed: May 27, 2025

(30) Foreign Application Priority Data
Jun. 3, 2024 (JP) 2024-089895

(51) Int. Cl. H01R 13/436

(52) U.S. Cl. CPC H01R 13/4364

(57) ABSTRACT

In a connector including a housing including a hood portion including an inner surface formed to have a curved shape, a terminal being accommodated in the housing, and a holder being accommodated inside the hood portion and including an outer surface facing the inner surface of the hood portion, the outer surface being formed to have a curved shape, the inner surface of the hood portion is provided with a plurality of looseness suppressing ribs that press the outer surface of the holder, the outer surface of the holder is provided with a flat portion formed to have a flat shape, the inner surface of the hood portion is provided with a facing flat portion formed to have a flat shape parallel to the flat portion, the inner surface facing the flat portion, and the facing flat portion is provided with a position restricting rib that presses the flat portion.

### CROSS-REFERENCE TO RELATED APPLICATIONS

The present application is based on, and claims priority from the prior Japanese Patent Application No. 2024-089895, filed on Jun. 3, 2024, the entire contents of which are incorporated herein by reference.

### TECHNICAL FIELD

The present disclosure relates to a connector.

### BACKGROUND

Hitherto, there has been known a connector that includes a housing including a hood portion including an inner surface formed to have a curved shape, a terminal that is accommodated in a housing, and a holder that is accommodated inside the hood portion (see Japanese Unexamined Patent Application Publication No. H9-45411). In the connector, the holder is provided with a pair of base plate portions that are formed to have a flat shape and an elastic portion that couples the pair of base plate portions and is elastically deformable. Inside the hood portion, guide walls formed to have a flat shape are provided respectively to abut against the pair of base plate portions. The interval between the pair of base plate portions is set to be larger than the interval between the two guide walls. Thus, the holder is accommodated in the hood portion while the pair of base plate portions apply a biasing force to the respective guide walls due to the restoration from the elastic deformation of the elastic portion, and looseness is suppressed.

### SUMMARY OF THE INVENTION

Incidentally, the connector in Japanese Unexamined Patent Application Publication No. H9-45411 has a relatively large space inside the hood portion. Thus, the flat guide wall can be provided inside the hood portion, and can abut against the flat base plate portion of the holder. However, for example, when a flat portion cannot be provided inside the hood portion due to size reduction of the connector, the outer surface of the holder may be required to abut against the inner surface of the hood portion. The inner surface of the hood portion is formed to have a curved shape. When the outer surface of the holder, which abuts against the inner surface having a curved shape, is a flat shape similar to the base plate portion, it may cause looseness. Thus, it is also required to form the outer surface of the holder into a curved shape. However, when the curved surfaces abut against each other due to the restoration from the elastic deformation of the holder itself, there may be variations in the contact between the respective abutting surfaces. Consequently, looseness suppression of the holder may not be stabilized.

The present disclosure has been made in view of such a problem in the related art. Further, an object of the present disclosure is to provide a connector that can stably suppress looseness of a holder and can achieve size reduction.

A connector according to the present embodiment includes a housing including a hood portion including an inner surface formed to have a curved shape, a terminal being accommodated in the housing, and a holder being accommodated inside the hood portion and including an outer surface facing the inner surface of the hood portion, the outer surface being formed to have a curved shape, wherein the inner surface of the hood portion is provided with a plurality of looseness suppressing ribs that press the outer surface of the holder, the outer surface of the holder is provided with a flat portion formed to have a flat shape, the inner surface of the hood portion is provided with a facing flat portion formed to have a flat shape parallel to the flat portion, the inner surface facing the flat portion, and the facing flat portion is provided with a position restricting rib that presses the flat portion.

According to the present disclosure, it is possible to provide a connector that can stably suppress looseness of a holder and can achieve size reduction.

### BRIEF DESCRIPTION OF DRAWINGS

FIG. 1 is an exploded perspective view of a connector according to the present embodiment.

FIG. 2 is a front view of the connector according to the present embodiment.

FIG. 3 is a perspective view of a housing of the connector according to the present embodiment.

FIG. 4 is a perspective view of the housing of the connector according to the present embodiment.

FIG. 5 is a perspective view of a holder of the connector according to the present embodiment.

### DETAILED DESCRIPTION OF THE INVENTION

With reference to the drawings, a connector according to the present embodiment is described below in detail. Note that the dimensional ratios in the drawings are exaggerated for explanatory purposes, and may differ from the actual ratios.

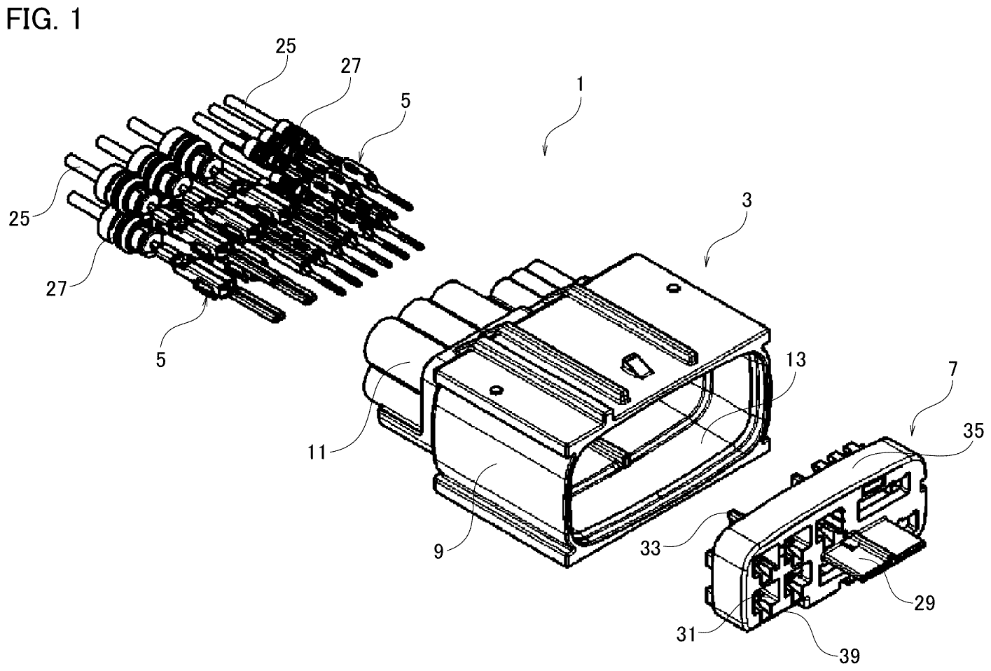

As illustrated in FIG. 1, a connector 1 according to the present embodiment connects two electric components (omitted in illustration), for example, a power source and a device or a device and a device to each other. For example, the connector 1 is electrically connected to one electric component. The connector 1 can be fitted to a mating connector (omitted in illustration) that is electrically connected to the other electric component. The connector 1 is fitted to the mating connector, and thus the two electric components are electrically connected to each other.

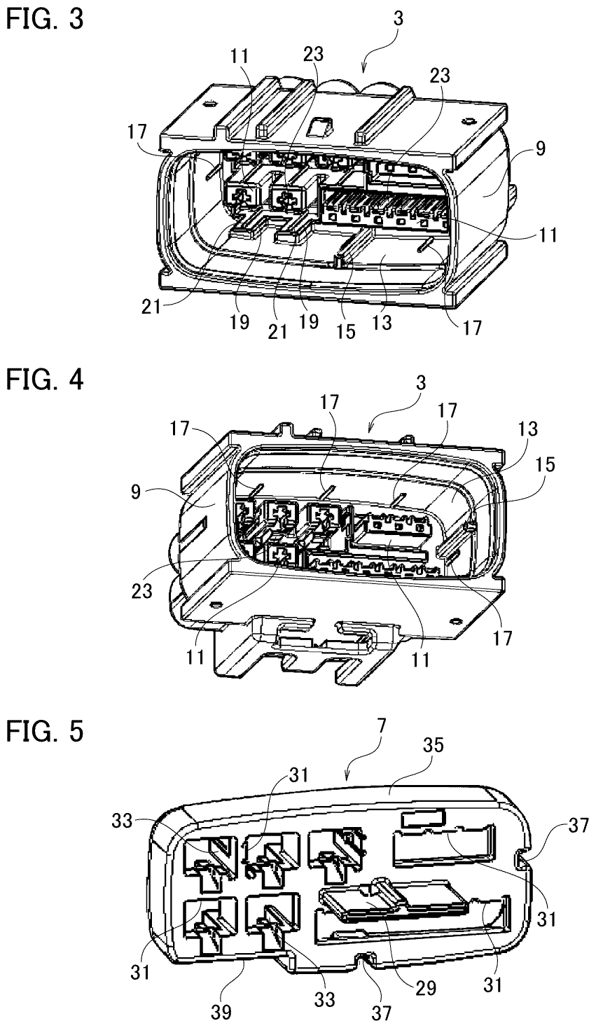

As illustrated in FIG. 1 to FIG. 5, the connector 1 includes a housing 3, a terminal 5, and a holder 7.

As illustrated in FIG. 1 to FIG. 4, the housing 3 is formed of an insulating material such as a synthetic resin. The housing 3 includes a hood portion 9 and a terminal accommodation chamber 11.

The hood portion 9 is formed to have a rectangular casing to which a mating housing of the mating connector (omitted in illustration) can be fitted. The front side of the hood portion 9 in a fitting direction with respect to the mating housing is opened, and the rear side thereof in the fitting direction with respect to the mating housing is closed. An inner surface 13 of the hood portion 9 is formed to have a curved shape having rounded corner portions and side portions slightly curved outward in order to improve contactness with a sealing member (omitted in illustration) such as a packing material that seals the space with the mating housing. The inner surface 13 of the hood portion 9 is provided with a plurality of (specifically, two in this case) guide ribs 15 that protrude toward the inside of the hood portion 9. The guide ribs 15 extend along an insertion direction of the holder 7 with respect to the hood portion 9.

The inner surface 13 of the hood portion 9 is provided with a plurality of (specifically, seven in this case) looseness suppressing ribs 17 that protrude toward the inside of the hood portion 9. The plurality of looseness suppressing ribs 17 extend along the insertion direction of the holder 7 with respect to the hood portion 9. The plurality of looseness suppressing ribs 17 are arranged so that at least one of them is positioned at each of the four side portions in a circumferential direction of the hood portion 9. In the present embodiment, one of them is arranged at each of the short side portions on both the side walls, three of them are arranged at the long side portion of the upper wall, and two of them are arranged at the long side portion of the lower wall. At least one of the looseness suppressing ribs 17 is arranged at each of the four side portions. With this, looseness of the holder 7 can be suppressed evenly in the circumferential direction of the hood portion 9.

The inner surface 13 of the hood portion 9 is provided with a plurality of (specifically, two in this case) facing flat portions 19 that protrude toward the inside of the hood portion 9. The facing flat portions 19 include surfaces in a protrusion direction that are formed to have a flat shape. The plurality of facing flat portions 19 each have a predetermined width, and extend along the insertion direction of the holder 7 with respect to the hood portion 9. Each of the plurality of facing flat portions 19 is provided with a position restricting rib 21 that protrudes toward the inside of the hood portion 9. The position restricting rib 21 extends along the insertion direction of the holder 7 with respect to the hood portion 9.

A plurality of terminal accommodation chambers 11 are provided inside the hood portion 9. In the present embodiment, there are provided five terminal accommodation chambers 11 each of which is defined to have one space, one terminal accommodation chamber 11 defined to have three spaces, and one terminal accommodation chamber 11 defined to have six spaces. The plurality of terminal accommodation chambers 11 extend along the fitting direction of the connector 1 and the mating connector. Both sides of each of the plurality of terminal accommodation chambers 11 in the extension direction are opened. An opening of the terminal accommodation chamber 11 on one side serves as an insertion opening through which the terminal 5 can be inserted into the terminal accommodation chamber 11. The opening of the terminal accommodation chamber 11 on the other side serves as a connection opening where the terminal 5 and the mating terminal of the mating connector (omitted in illustration) are electrically connected to each other.

A locking lance 23 that can be engaged with the terminal 5 is provided in an elastically deformable manner to each of the plurality of terminal accommodation chambers 11. Through engagement with the terminal 5, the locking lance 23 suppresses the terminal 5 from coming out of the insertion opening of the terminal accommodation chamber 11, and holds the terminal 5 in the housing 3. Among the plurality of locking lances 23, the locking lance 23 at which the position restricting rib 21 is positioned is arranged to face the position restricting rib 21 in an elastic deformation direction. When the locking lance 23 facing the position restricting rib 21 is elastically deformed at an excessive extent, the locking lance 23 abuts against the position restricting rib 21. Thus, excessive elastic deformation of the locking lance 23 can be suppressed, deformation or a damage to the locking lance 23 can be prevented, and the terminal 5 can be stably held in the housing 3. The terminal 5 is accommodated in the terminal accommodation chamber 11 provided with the locking lance 23 through the insertion opening.

As illustrated in FIG. 1, a plurality of terminals 5 each of which is formed of a conductive material are used so as to be accommodated respectively in the plurality of terminal accommodation chambers 11. In the present embodiment, five large-size terminals 5 such as electric terminals are used, and nine small-size terminals 5 such as communication terminals are used. The plurality of terminals 5 are formed of a male-type terminal each including a tab-like connection portion. Each of the plurality of terminals 5 is electrically connected by crimping or the like to a terminal end portion of an electric wire 25 that is electrically connected to the one electric component. A waterproof plug 27 is mounted on the outer periphery of the electric wire 25. The waterproof plug 27 closely adheres to the inner surface of the terminal accommodation chamber 11, and seals the space between the housing 3 and the electric wire 25. The terminal 5 is inserted through the insertion opening of the terminal accommodation chamber 11, is engaged with the locking lance 23, and then is held inside the terminal accommodation chamber 11. When the terminal 5 is accommodated in the terminal accommodation chamber 11, the tab-like connection portion is inserted through the connection opening, and the tab-like connection portion is arranged at the hood portion 9. When the connector 1 and the mating connector are fitted to each other, the tab-like connection portion arranged at the hood portion 9 is inserted into a box-like connection portion of the mating terminal, and the terminal 5 and the mating terminal are electrically connected to each other. The holder 7 detects an accommodation state of the terminal 5 with respect to the housing 3.

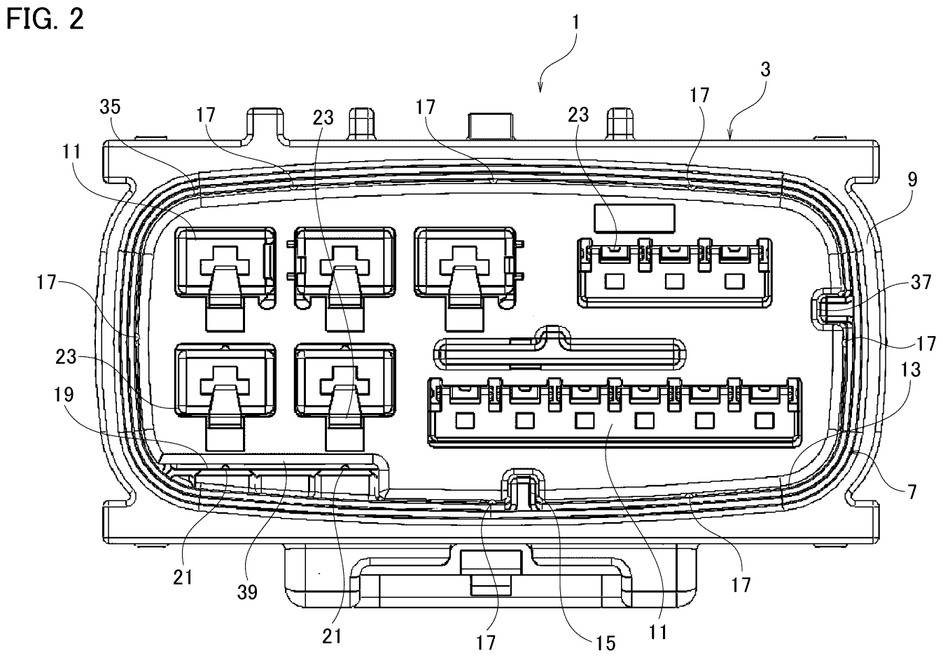

As illustrated in FIG. 1, FIG. 2, and FIG. 5, the holder 7 is formed of an insulating material such as a synthetic resin. The holder 7 is formed to have a rectangular lid-like shape that can be accommodated in the hood portion 9 so as to close the hood portion 9. The holder 7 is accommodated so as to be movable between a temporary locking position and a final locking position inside the hood portion 9. Note that a holding portion that holds the holder 7 between the temporary locking position and the final locking position may be provided between the holder 7 and the housing 3. On a side of the holder 7, which is close to the opening of the hood portion 9, an operation portion 29 is provided. For example, an operator grips the operation portion 29 to operate the holder 7. A plurality of (specifically, seven in this case) through holes 31 from which the connection openings and the locking lances 23 of the terminal accommodation chamber 11 are exposed are provided in the holder 7 so as to correspond with the plurality of terminal accommodation chambers 11. When the holder 7 is at the final locking position, the tab-like connection portion of the terminal 5 is arranged in the through hole 31, and the terminal 5 and the mating terminal can be electrically connected to each other while the connector 1 and the mating connector are fitted to each other. In addition, when the holder 7 is at the temporary locking position, a jig (omitted in illustration) that elastically deforms the locking lance 23 can be inserted into the through hole 31. The locking lance 23 can be elastically deformed by the jig, and then the terminal 5 can be extracted from the terminal accommodation chamber 11.

A detection portion 33 extends from the holder 7 toward the housing 3 side. A plurality of detection portions 33 are provided corresponding to the plurality of locking lances 23, respectively. The detection portion 33 can be inserted into an allowance space that allows elastic deformation of the locking lance 23. When the holder 7 is at the temporary locking position with respect to the hood portion 9, the detection portion 33 is kept on standby so as not to be inserted into the allowance space. Thus, the locking lance 23 is in an elastically deformable state, and the terminal 5 can be accommodated in the terminal accommodation chamber 11. When the holder 7 is at the final locking position with respect to the hood portion 9, the detection portion 33 is inserted into the allowance space. In this state, when the terminal 5 is arranged normally in the terminal accommodation chamber 11, the locking lance 23 is restored from elastic deformation, and the detection portion 33 can be inserted into the allowance space. Consequently, the holder 7 can be moved from the temporary locking position to the final locking position. In contrast, when the terminal 5 is not arranged normally in the terminal accommodation chamber 11, the locking lance 23 is in an elastically deformed state, and the detection portion 33 cannot be inserted into the allowance space. Consequently, the holder 7 cannot be moved from the temporary locking position to the final locking position. In this manner, the accommodation state of the terminal 5 with respect to the housing 3 can be detected based on the arrangement position of the holder 7 with respect to the hood portion 9.

Similarly to the inner surface 13 of the hood portion 9, an outer surface 35 of the holder 7, which faces the inner surface 13 of the hood portion 9, is formed to have a curved shape having rounded corner portions and side portions slightly curved outward. In the outer surface 35 of the holder 7, a plurality of (specifically, two in this case) guide grooves 37 that can be engaged with the guide ribs 15 are formed at positions corresponding to the plurality of guide ribs 15 of the hood portion 9. Through engagement between the guide ribs 15 and the guide grooves 37, movement of the holder 7 with respect to the hood portion 9 can be guided. The outer surface 35 of the holder 7 is provided with a flat portion 39, which is formed to have a flat shape parallel to the facing flat portion 19, at a position facing the plurality of facing flat portions 19 of the hood portion 9.

The curved outer surface 35 of the holder 7 is pressed toward the inside of the hood portion 9 by the plurality of (specifically, seven in this case) looseness suppressing ribs 17 of the hood portion 9 while the holder 7 is accommodated in the hood portion 9. When the looseness suppressing rib 17 presses the curved outer surface 35, which does not involve abutting between curved surfaces, looseness of the holder 7 can be suppressed stably without variations in the contact between the respective abutting surfaces. While the holder 7 is accommodated in the hood portion 9, the flat portion 39 of the holder 7 is pressed toward the inside of the hood portion 9 by the position restricting rib 21 of the facing flat portion 19. When the position restricting rib 21 of the facing flat portion 19 presses the flat portion 39, variations in the arrangement position of the holder 7 with respect to the hood portion 9 can be restricted. Thus, looseness of the holder 7 can be suppressed between the inner surface 13 of the hood portion 9 and the outer surface 35 of the holder 7 without providing a structure for suppressing looseness of the holder 7 inside the hood portion 9, and the connector 1 can be reduced in size.

In an example of assembling the connector 1 described above, first, the holder 7 is inserted into the hood portion 9. In this state, the outer surface 35 of the holder 7 is pressed by the looseness suppressing rib 17, and the flat portion 39 of the holder 7 is pressed by the position restricting rib 21. With this, looseness of the holder 7 is suppressed while restricting variations in the arrangement position of the holder 7 with respect to the hood portion 9. Subsequently, the holder 7 is moved until the holder 7 is located at the temporary locking position. Subsequently, the terminal 5 is accommodated in the housing 3. Then, the holder 7 is moved until the holder 7 is located at the final locking position, and assembly of the connector 1 is completed.

The connector 1 described above includes the housing 3 that includes the hood portion 9 including the inner surface 13 formed to have a curved shape, the terminal 5 that is accommodated in the housing 3, and the holder 7 that is accommodated inside the hood portion 9 and includes the outer surface 35 facing the inner surface 13 of the hood portion 9, the outer surface 35 being formed to have a curved shape. Further, the inner surface 13 of the hood portion 9 is provided with the plurality of looseness suppressing ribs 17 that press the outer surface 35 of the holder 7. Further, the outer surface 35 of the holder 7 is provided with the flat portion 39 formed to have a flat shape. Further, the inner surface 13 of the hood portion 9, which faces the flat portion 39, is provided with the facing flat portion 19 formed to have a flat shape parallel to the flat portion 39. Moreover, the facing flat portion 19 is provided with the position restricting rib 21 that presses the flat portion 39.

The curved outer surface 35 of the holder 7 is pressed toward the inside of the hood portion 9 by the plurality of looseness suppressing ribs 17 of the hood portion 9. When the looseness suppressing rib 17 presses the curved outer surface 35, which does not involve abutting between curved surfaces, looseness of the holder 7 can be suppressed stably without variations in the contact between the respective abutting surfaces. The flat portion 39 of the holder 7 is pressed toward the inside of the hood portion 9 by the position restricting rib 21 of the facing flat portion 19. When the position restricting rib 21 of the facing flat portion 19 presses the flat portion 39, variations in the arrangement position of the holder 7 with respect to the hood portion 9 can be restricted. Thus, looseness of the holder 7 can be suppressed between the inner surface 13 of the hood portion 9 and the outer surface 35 of the holder 7 without providing a structure for suppressing looseness of the holder 7 inside the hood portion 9, and the connector 1 can be reduced in size.

Therefore, the connector 1 described above can stably suppress looseness of the holder 7, and can achieve size reduction.

Further, the housing 3 is provided with the locking lance 23 that is engaged with the terminal 5, holds the terminal 5 in the housing 3, and is elastically deformable. Further, the position restricting rib 21 is arranged to face the locking lance 23 in the elastic deformation direction of the locking lance 23.

When the locking lance 23 facing the position restricting rib 21 is elastically deformed at an excessive extent, the locking lance 23 abuts against the position restricting rib 21. Thus, excessive elastic deformation of the locking lance 23 can be suppressed, deformation or a damage to the locking lance 23 can be prevented, and the terminal 5 can be stably held in the housing 3.

Further, the holder 7 detects the accommodation state of the terminal 5 with respect to the housing 3, based on the arrangement position with respect to the hood portion 9.

Looseness of the holder 7 with respect to the hood portion 9 is suppressed. Thus, the arrangement position of the holder 7 with respect to the hood portion 9 can be varied stably, and the accommodation state of the terminal 5 with respect to the housing 3 can be detected stably.

While the present embodiment is described above, the present embodiment is not limited thereto, and various modifications can be made within the scope of the gist of the present embodiment.

For example, the seven looseness suppressing ribs are provided, but the number thereof is not limited thereto. Six or fewer or eight or more looseness suppressing ribs may be provided.

Further, the two facing flat portions and the two position restricting ribs are provided, but the numbers thereof are not limited thereto. Three or more facing flat portions and three or more position restricting ribs may be provided. Moreover, a plurality of position restricting ribs may be provided with respect to one facing flat portion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a housing including a hood portion including an inner surface formed to have a curved shape;
a terminal being accommodated in the housing; and
a holder being accommodated inside the hood portion and including an outer surface facing the inner surface of the hood portion, the outer surface being formed to have a curved shape, wherein
the inner surface of the hood portion is provided with a plurality of looseness suppressing ribs that press the outer surface of the holder,
the outer surface of the holder is provided with a flat portion formed to have a flat shape,
the inner surface of the hood portion is provided with a facing flat portion formed to have a flat shape parallel to the flat portion, the inner surface facing the flat portion, and
the facing flat portion is provided with a position restricting rib that presses the flat portion.

2. The connector according to claim 1, wherein
the housing is provided with a locking lance that is engaged with the terminal, holds the terminal in the housing, and is elastically deformable, and
the position restricting rib is arranged to face the locking lance in an elastic deformation direction of the locking lance.

3. The connector according to claim 1, wherein
the holder detects an accommodation state of the terminal with respect to the housing, based on an arrangement position with respect to the hood portion.
